(19) United States
(12) Patent Application Publication
(10) Pub. No.: US 2009/0044755 A1
(43) Pub. Date: Feb. 19, 2009

(54) PET FEEDING DISH WITH TREAT CHAMBER

(76) Inventor: Benjamin Volotzky, Chatsworth, CA (US)

Correspondence Address: LYON & HARR, LLP, 300 ESPLANADE DRIVE, SUITE 800, OXNARD, CA, 93036, US

(21) Appl. No.: 11/840,980

(22) Filed: Aug. 19, 2007

(51) Int. Cl. A01K 5/01

(52) U.S. Cl. 119/61.54; 119/61.5

(57) ABSTRACT

The present dish provides a novel way to feed pets which entices them to eat the entirety of a routinely apportioned amount of food. The dish includes a food bowl and treat chamber. The bowl is located at the top of the dish, and includes an open top and side walls which taper downwardly inward to a passageway at the bottom of the bowl. The chamber is located beneath the bowl, and includes an open top, which forms the passageway, and a closed bottom. A treat is placed into the chamber and then food is placed into the bowl such that it covers the treat. The food falls toward the passageway into the chamber so that, regardless of how vigorously the pet noses through the food in an attempt to just eat the treat, the treat will remain covered by the food until the pet eats all the food.

### BACKGROUND

Pre-packaged pet food is a popular way to feed dogs, cats and other types of pets. For example, feeding a pet pre-packaged food is convenient for pet owners. There are a wide variety of different forms pet food takes including dry food, soft-moist food and canned food. Feeding a pet pre-packaged food is nutritious for the pet since this type of food is typically specially formulated to meet the particular nutrition and health needs of a wide variety of animals. Furthermore, pre-packaged pet foods exist which are specially adapted to meet a pet's changing needs as the pet ages or when the animal is sick. Thus, feeding pre-packaged pet food to an animal is a daily ritual for many pet owners.

### SUMMARY

This Summary is provided to introduce a selection of concepts, in a simplified form, that are further described hereafter in the Detailed Description. This Summary is not intended to identify key features or essential features of the claimed subject matter, nor is it intended to be used as an aid in determining the scope of the claimed subject matter.

The present pet feeding dish generally provides pet owners and other types of animal attendants with a novel and effective way to feed their pet/animal pet food which entices and trains the pet/animal to eat the entirety of a routinely apportioned amount of food that is both convenient and properly tailored to the pet's/animal's particular nutrition and health needs. In one embodiment the present pet feeding dish includes a food bowl and a treat chamber. The food bowl is located at the top of the present dish. The top of the food bowl is open. Side walls of the food bowl descend from the open top and taper downwardly inward to a passageway at the bottom of the food bowl. The treat chamber is located beneath the food bowl. The treat chamber includes an open top, which forms the passageway, and a closed bottom. A treat is placed into the treat chamber and then food is placed into the food bowl such that it covers the treat.

In addition to the just described benefits, other advantages of the present invention will become apparent from the detailed description which follows hereinafter when taken in conjunction with the drawing figures that accompany it.

### DESCRIPTION OF THE DRAWINGS

The specific features, aspects, and advantages of the present pet feeding dish will become better understood with regard to the following description, appended claims, and accompanying drawings where:

FIG. 1 illustrates a top plan view of an exemplary embodiment of the present pet feeding dish.

FIG. 2 illustrates an exemplary cross-sectional side view of an embodiment of the present pet feeding dish taken along line A-A of FIG. 1.

FIG. 3 illustrates an exemplary cross-sectional side view of another embodiment of the present pet feeding dish taken along line A-A of FIG. 1.

FIG. 4 illustrates an exemplary cross-sectional side view of yet another embodiment of the present pet feeding dish taken along line A-A of FIG. 1.

### DETAILED DESCRIPTION

In the following description of embodiments of the present pet feeding dish reference is made to the accompanying drawings which form a part hereof, and in which are shown, by way of illustration, specific embodiments in which the present dish may be practiced. It is understood that other embodiments may be utilized and structural changes may be made without departing from the scope of the present dish. It is noted that the term “pet” is used herein to refer to any type of animal including, but not limited to a domesticated animal kept as a pet or an animal kept in a zoo. It is also noted that the term “pet food” is used herein to refer to a wide variety of different types of prescribed animal food including, but not limited to, the dry, soft-moist and canned varieties of pre-packaged pet food. It is also noted that the term “treat” is used herein to refer to something that a particular pet finds highly palatable. Exemplary types of treats include, but are not limited to, a portion of either cooked or raw human food such as meat, or a pre-packaged item such as a dog biscuit. Some types of treats such as meat are readily smelled by pets whereas other types of treats may not be.

### 1.0 Pet Feeding Dish With Treat Chamber

As noted heretofore, the present pet feeding dish generally provides a novel and effective way to feed pets which entices and trains a pet to eat the entirety of a routinely apportioned amount of pet food that is both convenient and properly tailored to the pet's particular nutrition and health needs. This section is devoted to a description of various exemplary embodiments of the present dish.

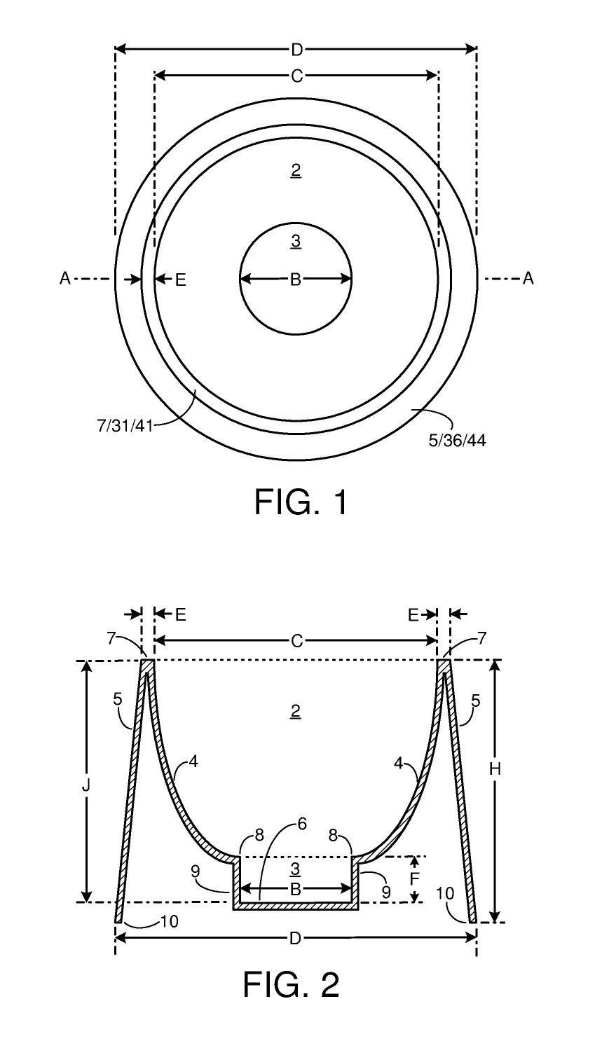

FIGS. 1 and 2 illustrate one exemplary embodiment of the present pet feeding dish. More particularly, FIG. 1 illustrates a top plan view of an exemplary embodiment of the present dish and FIG. 2 illustrates a cross-sectional side view of the exemplary dish taken along line A-A of FIG. 1. The dish can either be constructed as a single part, or as a plurality of parts which are put together. The dish includes an upper food bowl 2 and a lower treat chamber 3. The food bowl 2 is disposed at the top of the dish. The top of the food bowl 2 is open. Side walls of the food bowl 2 taper downwardly inward to a passageway at the bottom of the food bowl. The treat chamber 3 is disposed beneath the food bowl 2. The top of the treat chamber 3 opens into the passageway. The bottom of the treat chamber 3 is closed as will be described hereafter. The particular manner in which the side walls of the food bowl 2 taper to the passageway is variable.

FIG. 2 illustrates one embodiment of how the side walls of the food bowl 2 can taper downwardly inward to the passageway at the bottom of the food bowl. In this embodiment, the side walls of the food bowl 2 include a single section with sloped side walls 4 which taper downwardly inward along a curved path which starts at the top 7 of the present dish and ends at the passageway at the bottom 8 of the food bowl 2. The overall grade of this curved path is steep enough to cause any food within the food bowl 2 to fall toward the passageway and into the treat chamber 3.

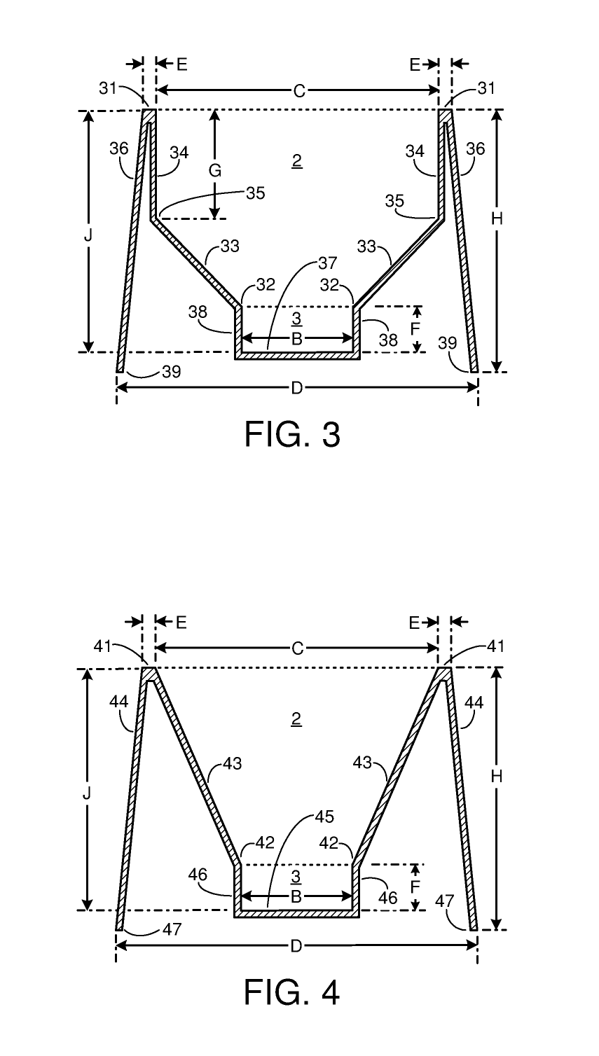

FIG. 3 illustrates another embodiment of how the side walls of the food bowl 2 can taper downwardly inward to the passageway at the bottom of the food bowl. More particularly, FIG. 3 illustrates an exemplary cross-sectional side view of another embodiment of the present pet feeding dish taken along line A-A of FIG. 1. In this embodiment, the side walls of the food bowl 2 include the following two different sections. An upper section has vertical food side walls 34 which start at the top 31 of the present dish and vertically drop a distance G. A lower section has sloped side walls 33 which taper downwardly inward along a linear slope which starts at the bottom edge 35 of the vertical food side walls 34 and ends at the passageway at the bottom 32 of the food bowl 2. The grade of this linear slope is steep enough to cause any food within the food bowl 2 to fall toward the passageway and into the treat chamber 3. It is noted that distance G is variable.

FIG. 4 illustrates yet another embodiment of how the side walls of the food bowl 2 can taper downwardly inward to the passageway at the bottom of the food bowl. More particularly, FIG. 4 illustrates an exemplary cross-sectional side view of yet another embodiment of the present pet feeding dish taken along line A-A of FIG. 1. In this embodiment, the side walls of the food bowl 2 include a single section with sloped side walls 43 which taper downwardly inward along a linear slope which starts at the top 41 of the present dish and ends at the passageway at the bottom 42 of the food bowl 2. The grade of this linear slope is again steep enough to cause any food within the food bowl 2 to fall toward the passageway and into the treat chamber 3.

Referring again to FIGS. 1-4, in one embodiment the treat chamber 3 includes side walls 9/38/46 which start at the bottom edge 8/32/42 of the side walls of the food bowl 2 and vertically drop a distance F. The treat chamber 3 also includes a bottom wall 6/37/45 which is attached across the bottom edge of the side walls 9/38/46, thus serving to close the bottom of the treat chamber. In this embodiment the treat chamber 3 forms a downward cavity which has a cylindrical shape. In another embodiment (not illustrated) the aforementioned side walls of the treat chamber taper downwardly inward along a linear slope such that the treat chamber forms a downward cavity which has a conical shape that is truncated by the bottom wall. In yet another embodiment (not illustrated) the aforementioned side walls of the treat chamber taper downwardly inward along a stepped slope such that the treat chamber forms a downward cavity which has an inwardly stepped shape that is truncated by the bottom wall.

Referring again to FIGS. 2-4, although the bottom wall 6/37/45 of the illustrated treat chamber 3 has a surface geometry which is a flat, other embodiments (not illustrated) are also possible in which the bottom wall has a surface geometry which is downwardly concave or a downwardly conical. Another embodiment (not illustrated) is also possible in which no bottom wall exists, but rather, the side walls of the treat chamber open to a passageway at the bottom of the treat chamber. In this embodiment a removable cap can be installed onto the bottom of this passageway in order to close the bottom of the treat chamber. The cap can be removed as necessary to provide for easy cleaning of the food bowl and treat chamber.

The downward cavity formed by the treat chamber can also have a variety of other shapes. By way of example, but not limitation, in one embodiment (not illustrated) the treat chamber includes side walls which start at the bottom edge of the side walls of the food bowl and taper downwardly inward along a linear slope to a common point of convergence, such that the treat chamber forms a downward cavity which has an un-truncated conical shape. In another embodiment (not illustrated) the treat chamber includes side walls which start at the bottom edge of the side walls of the food bowl and taper downwardly inward along a curved path to a common point of convergence, such that the treat chamber forms a downward cavity which has a bowl shape.

Referring again to FIGS. 1-4, the present dish also includes exterior side walls 5/36/44 which start at the top 7/31/41 of the dish and taper downwardly outward away from the treat chamber 3. The exterior side walls 5/36/44 vertically drop a distance H from the top 7/31/41 of the dish, where distance H is variable. However, distance H should be prescribed such that it is greater than the vertical height J of the downward cavity formed by the combination of the food bowl 2 and treat chamber 3, where height J is also variable. This assumes that the bottom edge 10/39/47 of the exterior side walls 5/36/44 comes in contact with the ground in order to provide a stable supporting base for the dish. In general, distance H and height J are prescribed based on criteria such as the particular type of pet the dish is meant to feed. The particular manner in which the exterior side walls 5/36/44 taper outward is variable. FIGS. 2-4 illustrate embodiments of the dish in which the exterior side walls 5/36/44 taper downwardly outward along a linear slope. Other embodiments (not illustrated) are also possible in which the exterior side walls 5/36/44 taper downwardly outward along a curved path or a stepped slope. The grade of the path/slope of the exterior side walls 5/36/44 is also variable. Other embodiments (not illustrated) are also possible in which the exterior side walls 5/36/44 are vertical, or even taper inward.

Referring again to FIGS. 1-4, the top opening of the food bowl 2 has a width C which is variable. In general, width C is prescribed based on criteria such as the particular type of pet the present dish is meant to feed, among other things. As described heretofore, the bottom edge 10/39/47 of the exterior side walls 5/36/44 forms a supporting base for the present dish. This supporting base has a width D which is variable. The treat chamber 3 has a width B and depth F which are variable. In general, width B and depth F are prescribed based on criteria such as the particular type of pet the present dish is meant to feed along with the related type and size of treat to be placed in the treat chamber 3, among other things.

### 1.1 Operational Description

Referring again to FIGS. 1-4, this section describes the operation of the present pet feeding dish during a typical pet feeding session. The pet's owner first places a treat into the treat chamber 3 and then places a desired portion of pet food into the food bowl 2 such that it covers the treat. The pet's owner can optionally choose to show the treat to the pet as it is being placed into the treat chamber 3 in order to enhance the pet's awareness of the treat. It is noted that this optional step is not typically necessary since, for many types of treats and pets, the pet can smell the treat through the pet food. However, this optional step may become necessary for situations in which a particular combination of treat and pet results in the pet not being able to readily smell the treat. The pet's attraction to the pet food in the food bowl 2 is enhanced by their awareness of the treat beneath the food due to their ability to smell the treat and/or their having seen the treat be placed beneath the food.

Referring again to FIGS. 1-4, regardless of how vigorously the pet noses through the pet food in an attempt to just eat the treat, the side walls of the food bowl 2 cause the food to fall on top of the treat. Additionally, as the pet attempts to push down through the food toward the treat, they are actually pushing more food on top of the treat. The end result is that the treat will remain covered by the food until the pet eats all of the food in the food bowl 2, which they will do in order to be able to eat the treat in the treat chamber 3. The fact that the pet gets to eat the treat each time they finish eating all the food serves as a positive reinforcement. Thus, the present pet feeding dish provides a novel and effective way to feed pets. The present dish can also be used quite effectively to train a new puppy to have good eating habits.

It is noted that if one were to place a treat into a conventional pet feeding dish and then place pet food over the treat, the pet will easily “nose through” the pet food to gain access to the treat. As a result, the pet will find and eat the treat but won't eat the pet food.

### 1.2 Additional Embodiments

While the present pet feeding dish has been described in detail heretofore by specific reference to embodiments thereof, it is understood that variations and modifications thereof may be made without departing from the true spirit and scope of the present dish. This section describes exemplary additional embodiments of the present dish.

Although FIG. 1 illustrates an embodiment in which the outside of the present dish, its food bowl 2 and treat chamber 3 are circular in shape as viewed from above, other shapes are also possible. For example, the outside of the dish, its food bowl 2 and treat chamber 3 can have a shape as viewed from above which is oval, square, rectangular, hexagonal or octagonal, among others. Additionally, the outside of the dish, its food bowl 2 and treat chamber 3 can each have a different shape as viewed from above. By way of example, but not limitation, the outside of the dish can have a hexagonal shape, the food bowl 2 can have a circular shape, and the treat chamber 3 can have a square shape as viewed from above. A particular shape(s) for the dish is generally prescribed based on factors such as a desired aesthetic, the material the dish will be constructed from, and the manufacturing method that will be used to construct the dish. The bottom 10/39/47 of the dish can include an upwardly hollow cavity as illustrated in FIGS. 2-4, or in another embodiment (not illustrated) this cavity can be filled in so that the bottom includes a flat surface. Whether or not the bottom 10/39/47 includes a hollow cavity is generally based on factors such as the material the dish will be constructed from and the manufacturing method that will be used. The width E of the top 7/31/41 of the dish is variable and is generally prescribed based on factors such as a desired aesthetic, the material the dish will be constructed from and the manufacturing method that will be used. The shape of the top 7/31/41 of the dish is also variable. For example, the top 7/31/41 of the dish can be flat as illustrated in FIGS. 2-4, or in another embodiment this top can be rounded.

The present dish can have a variety of different colors or a combination of colors which are generally prescribed based on a desired aesthetic. The dish can be surface decorated in a variety of different ways which are generally prescribed based on a desired aesthetic. For example, prescribed designs and/or patterns can be printed or embedded on the various surface(s) of the dish including its exterior side walls 5/36/44, top 7/31/41, side walls 4/34/33/43 of the food bowl 2, and side walls 9/38/46 and bottom surface 6/37/45 of the treat chamber 3. Other forms of surface decoration are also possible.

The present dish can be constructed from a variety of durable, non-porous materials such as glass, plastic, hard rubber, wood, coated metal, and certain types of non-coated metal, among others. The dish can be constructed using a variety of different manufacturing methods which are based upon the particular material being used. Exemplary manufacturing methods include molding the material, cutting the material, and stamping the material, among others.

It is noted that any or all of the aforementioned embodiments may be used in any combination desired to form additional hybrid embodiments. Although the present pet feeding dish has been described in language specific to structural features and/or methodological acts, it is to be understood that the subject matter defined in the appended claims is not necessarily limited to the specific features or acts described heretofore. Rather, the specific features and acts described heretofore are disclosed as example forms of implementing the claims.

Wherefore, what is claimed is:

1. An animal feeding dish, comprising:
a food bowl disposed at an upper part of the dish, wherein the bowl comprises an open top, and side walls which descend from the open top and taper downwardly inward to a passageway at a bottom of the bowl; and
a treat chamber disposed beneath the bowl, wherein the chamber comprises an open top which forms said passageway, and a closed bottom.

2. The dish of claim 1, wherein the dish is constructed as an integral, one piece unit.

3. The dish of claim 1, wherein,
the side walls of the bowl taper downwardly inward along a curved path, and wherein
an overall grade of the curved path is steep enough to cause food within the bowl to fall toward the passageway and into the chamber.

4. The dish of claim 1, wherein the side walls of the bowl comprise:
a vertically oriented upper section descending from the open top; and
a downwardly inward linear sloping lower section descending, from a bottom edge of the upper section of the side walls, to said passageway, wherein a grade of the linear slope is steep enough to cause food within the bowl to fall toward the passageway and into the chamber.

5. The dish of claim 1, wherein,
the side walls of the bowl taper downwardly inward along a linear slope, and wherein
a grade of the linear slope is steep enough to cause food within the bowl to fall toward the passageway and into the chamber.

6. The dish of claim 1, wherein the treat chamber comprises:
side walls which descend from a bottom edge of the side walls of the bowl at the passageway; and
a bottom wall which is disposed across a bottom edge of the side walls of the chamber, thus serving to close a bottom of the chamber.

7. The dish of claim 6, wherein the side walls of the chamber comprise one of:
vertically oriented walls, such that the chamber forms a downward cavity having a cylindrical shape;
downwardly inward linear sloping walls, such that the chamber forms a downward cavity having a truncated conical shape; or
downwardly inward stepped sloping walls, such that the chamber forms a downward cavity having an inwardly stepped shape.

8. The dish of claim 6, wherein a surface geometry of the bottom wall comprises one of:
a flat surface;
a downwardly concave surface; or
a downwardly conical surface.

9. The dish of claim 1, wherein the treat chamber comprises:
side walls which descend from a bottom edge of the side walls of the bowl at the passageway to a second passageway at a bottom of the chamber; and
a removable cap which is installed across a bottom edge of the side walls of the chamber, thus serving to close the second passageway at the bottom of the chamber, wherein the cap is removed as necessary to provide for easy cleaning of the bowl and chamber.

10. The dish of claim 1, wherein the treat chamber comprises side walls which descend from a bottom edge of the side walls of the bowl at the passageway and taper downwardly inward along a linear slope to a common point of convergence, such that the chamber forms a downward cavity having an un-truncated conical shape.

11. The dish of claim 1, wherein the treat chamber comprises side walls which descend from a bottom edge of the side walls of the bowl at the passageway and taper downwardly inward along a curved path to a common point of convergence, such that the chamber forms a downward cavity having a bowl shape.

12. The dish of claim 1, wherein a shape, as viewed from above, of the bowl comprises one of:
a circular shape;
an oval shape;
a square shape;
a rectangular shape;
a hexagonal shape; or
an octagonal shape.

13. The dish of claim 12, wherein a shape, as viewed from above, of the chamber is the same as said shape of the bowl.

14. The dish of claim 12, wherein a shape, as viewed from above, of the chamber is different than said shape of the bowl, and wherein said shape of the chamber comprises one of:
a circular shape;
an oval shape;
a square shape;
a rectangular shape;
a hexagonal shape; or
an octagonal shape.

15. The dish of claim 12, wherein an outer shape, as viewed from above, of the dish is the same as said shape of the bowl.

16. The dish of claim 12, wherein an outer shape, as viewed from above, of the dish is different than said shape of the bowl, and wherein said outer shape of the dish comprises one of:
a circular shape;
an oval shape;
a square shape;
a rectangular shape;
a hexagonal shape; or
an octagonal shape.

17. The dish of claim 1, wherein the dish is constructed from any of a variety of durable, non-porous materials.

18. An animal feeding dish, comprising:
a bowl means for retaining food for feeding an animal which comprises an open top and side walls that taper downwardly inward to a passageway at a bottom of the bowl means; and
a chamber means for retaining a treat favored by the animal which descends beneath the bowl means and comprises an open top that forms said passageway, wherein,
the side walls of the bowl means taper downwardly inward at a grade that is steep enough to cause the food to fall toward said passageway and into the chamber means so that, whenever the treat is placed in the chamber means and the food is placed in the bowl means covering the treat, regardless of how vigorously the animal noses through the food in an attempt to eat the treat, the treat will remain covered by the food until the animal eats all the food.

19. The dish of claim 18, further comprising a ground-support means for providing a stable base for the dish.

20. A pet feeding dish, comprising:
a supporting base;
a food bowl which is disposed at an upper part of the supporting base, wherein the bowl comprises an open top, and side walls which descend from the open top and taper downwardly inward to a passageway at a bottom of the bowl; and
a treat chamber which descends from the bottom of the bowl, wherein the chamber comprises an open top which forms said passageway, and a closed bottom; and wherein
the side walls of the bowl comprise a slope which is steep enough to cause pet food placed within the bowl to fall toward said passageway and into the chamber.
